(19) United States
(12) Patent Application Publication
(10) Pub. No.: US 2024/0130913 A1
(43) Pub. Date: Apr. 25, 2024

(54) Device Holder for Inversion Table

(71) Applicant: On Chong, Sunnyvale, CA (US)

(72) Inventor: On Chong, Sunnyvale, CA (US)

(73) Assignee: Innova Products, Inc., Sunnyvale, CA (US)

(21) Appl. No.: 18/400,418

(22) Filed: Dec. 29, 2023

Related U.S. Application Data
(63) Continuation-in-part of application No. 17/340,274, filed on Jun. 7, 2021.

(51) Int. Cl. A61G 13/10; A61G 13/00; A61H 1/02

(52) U.S. Cl. CPC A61G 13/101; A61G 13/009; A61H 1/0229; A61H 2201/0107; A61H 2201/1635

(57) ABSTRACT

A device holder for an inversion table. The device holder includes a clamp and a rigid body having a front portion, bottom portion, back portion, and lateral portions to retain a device placed into the device holder. The clamp may be removably attached to the inversion table or adjustable in different positions on the inversion table. The device holder body may be removably attached to the clamp. The device holder may be attached to a fixed, non-rotating part of the inversion table or it may be attached to the rotating part of the inversion table.

### CROSS REFERENCE TO RELATED APPLICATION

This application is a continuation-in-part of U.S. patent application Ser. No. 17/340,274 and is incorporated by reference herein in its entirety.

### FIELD OF THE INVENTION

Generally, the present invention relates to a device holder for an inversion therapy table that allows a user to place a device, such as a phone or tablet.

### DESCRIPTION OF RELATED ART

Inversion tables are known for stretching the lower back and for providing temporary back pain relief. More generally, inversion therapy involves lying flat on your back at an angle or hanging upside down, in head-down position.

Current inversion tables do not provide a place for a user to place a device, such as a phone or tablet, into or onto the inversion table. A user may want to have a device in or on the table and within reach for numerous reasons. For example, a user may want to listen to music, make a phone call, answer a phone call, use a timer or alarm function (which may be suggested by a physician), or any of the other functions provided by the device. The user also might wish to connect with their physician via a call or video for guidance or instruction.

The present disclosures address at least some of the issues described above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The embodiments herein provide for a system and apparatus wherein an inversion table includes a device holder. The device holder should retain the device and not allow it to fall out, which potentially can lead to damage of the device. The device holder should retain the device even while the user is inverted. As can be appreciated from the drawings and description herein, the device holder is made from a rigid material and is rigidly attached to the inversion table.

The present invention provides a device holder with a bottom portion, front portion, back portion, and lateral portions to retain a device, such as a phone or tablet. In one embodiment, the device holder is attached to the fixed, non-rotating part of the inversion table. This will allow the device to be retained even while the user is inverted on the rotatable part of the inversion table.

In another embodiment, the device holder is attached to the rotatable part of the inversion table and further includes a top portion or a mechanism at the top to retain the device and prevent the device from falling out of the device holder. This top portion or top mechanism is particularly useful if the user is inverted, such that the device holder likewise would be inverted.

In yet another embodiment, the device holder is removably attached to the inversion table, such as by a clamp. The body of the device holder may be removably attached to the clamp. Removable attachment allows the position of the device holder to be attached to different parts of the inversion table and allow a user to adjust the location of the device holder.

### BRIEF DESCRIPTION OF THE FIGURES

The disclosed subject matter will hereafter be described with reference to the accompanying drawings, wherein like reference numerals denote like elements, and:

FIG. 1 provides a perspective view of an inversion table with a device holder in accordance with some embodiments of the present invention.

FIG. 2 provides a closer perspective view of the inversion table with the device holder.

FIG. 3 provides another closer perspective view of the inversion table with the device holder.

FIG. 4 provides a front perspective view of the device holder.

FIG. 5 provides another front perspective view of the device holder.

FIG. 6 provides a rear perspective view of the device holder.

FIG. 7 provides another rear perspective view of the device holder.

FIG. 8 provides a perspective view of a further embodiment of the device holder.

FIG. 9 provides a right-side perspective view of a clamp of the device holder.

FIG. 10 provides a left-side perspective view of the clamp.

FIG. 11 provides a top view of the clamp.

FIG. 12 provides a perspective view of a body of the device holder.

FIG. 13 provides a front view of the device holder body.

FIG. 14 provides a side view of the device holder body.

FIG. 15 provides a perspective view of the device holder body prior to be attached to the clamp.

FIG. 16 provides a perspective view of the device holder clamp and body attached to a left arm of the inversion table.

FIG. 17 provides an additional perspective view of the device holder clamp and body attached to the left arm of the inversion table shown in FIG. 16.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims.

### DETAILED DESCRIPTION

Although specific embodiments of the present invention will now be described with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

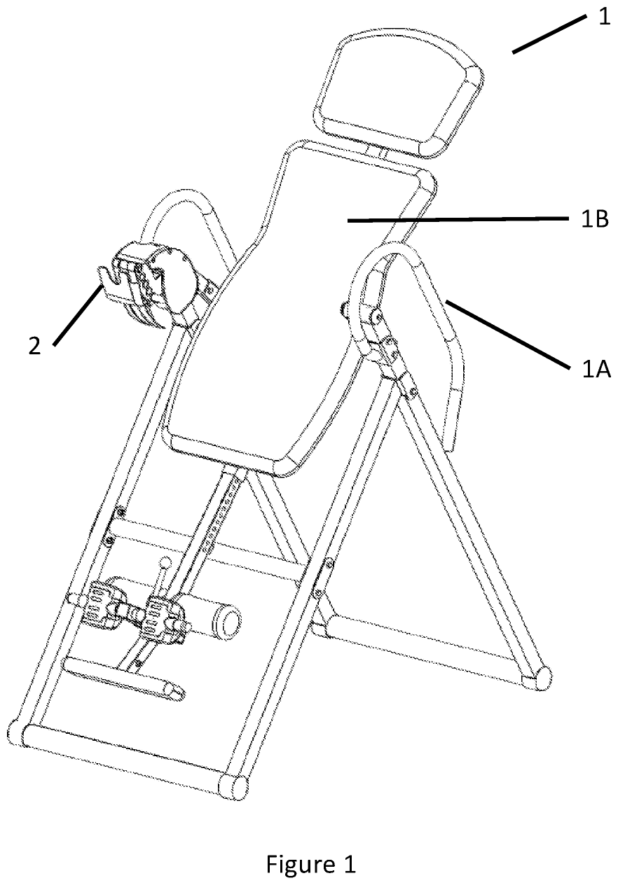

With reference to FIG. 1, an inversion table (1) is shown having a device holder (2). The inversion table (1) has a frame (1A) with a rotatable backrest (1B) attached rotatably thereto. The rotatable backrest (1B) can rotate with respect to the frame (1A), thereby providing inversion to a user.

The device holder (2) is attached to the frame (1A), thereby preventing rotation of the device holder if the backrest (1B) is rotated with respect to the frame (1A).

In a further embodiment, not shown here, the device holder may be attached to the rotatable backrest (1B) of the inversion table (1). The device holder (2) may further include a top portion or a strap, cap, or other similar structure or device to retain a device and prevent it from falling out of the device holder (2). This may be useful if the device holder (1) is inverted as the user is inverted.

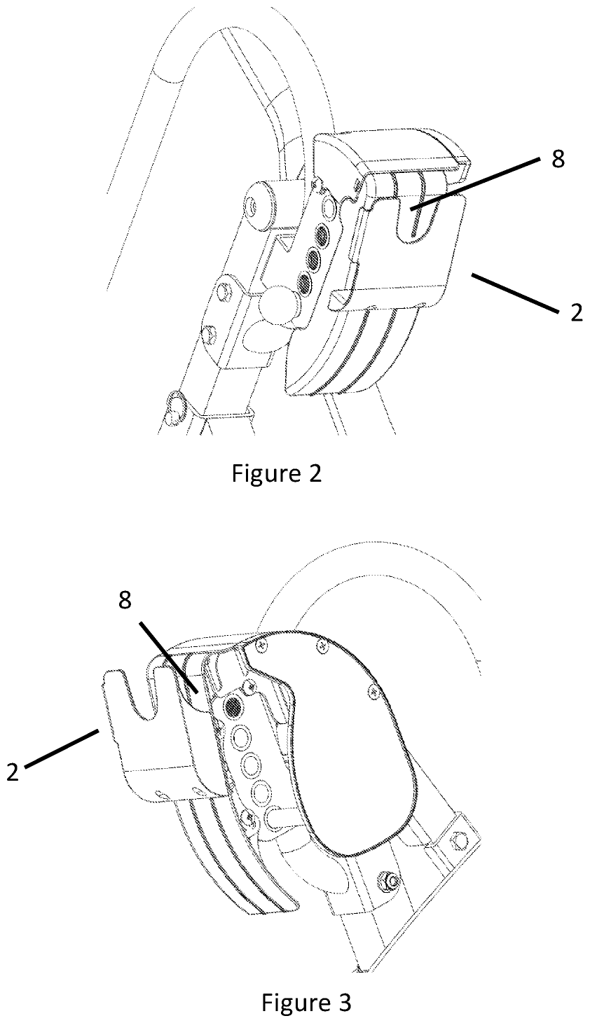

FIGS. 2 and 3 illustrate the device holder (2) attached to the frame (1A).

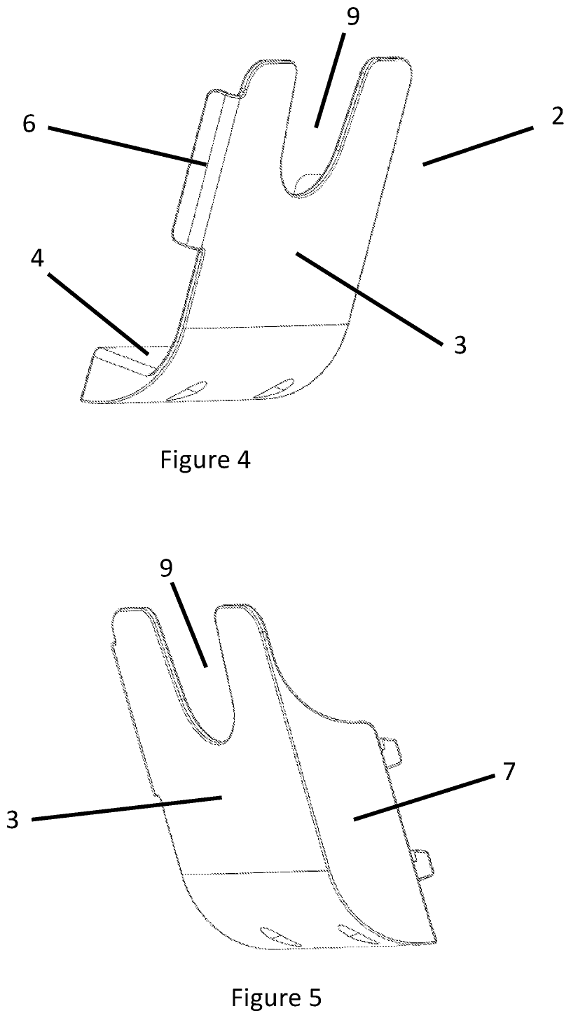

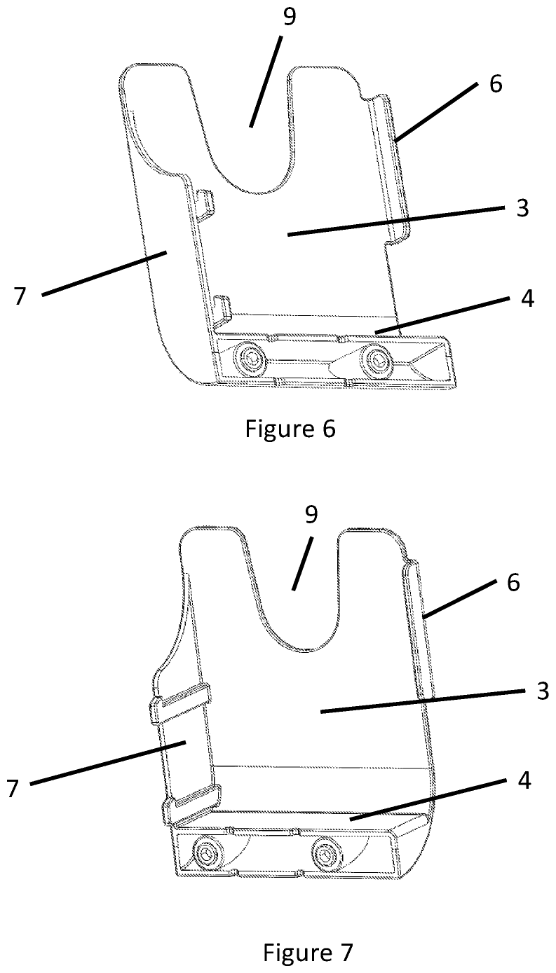

FIGS. 4-7 illustrate a front portion (3), bottom portion (4), and lateral portions (6 and 7) of the device holder (2). The front portion (3) is attached to the bottom portion (4). The lateral portions (6 and 7) are attached to the front portion (3). Although not illustrated here, the lateral portions (6 and 7) may be attached to the bottom portion (4).

FIGS. 2 and 3 also illustrate a back portion (8) of the device holder (2). The back portion (8) is attached to the bottom portion (4). Although not illustrated here, the back portion (8) may be attached to a lateral portion (7).

Together, the front portion (3), bottom portion (4), back portion (8), and lateral portions (6 and 7) serve to retain a device and prevent it from falling out, including if the user is inverting or inverted on the backrest (1B).

In another embodiment, the device holder (2) may include a slot (9) in the front portion (3). The slot (9) serves to aid in grabbing a device from the device holder, which may be particularly useful if the device is shorter than the height of the front portion (3). The slot (9) also makes a device in the device holder more visible. The slot (9) also provides room for devices that have attachments that otherwise would make the device too thick to fit in the device holder. Such an attachment may include a phone grip or similar device attached to a device.

As can appreciated from the figures and aforementioned description, the device holder is made from a rigid material, such as plastic.

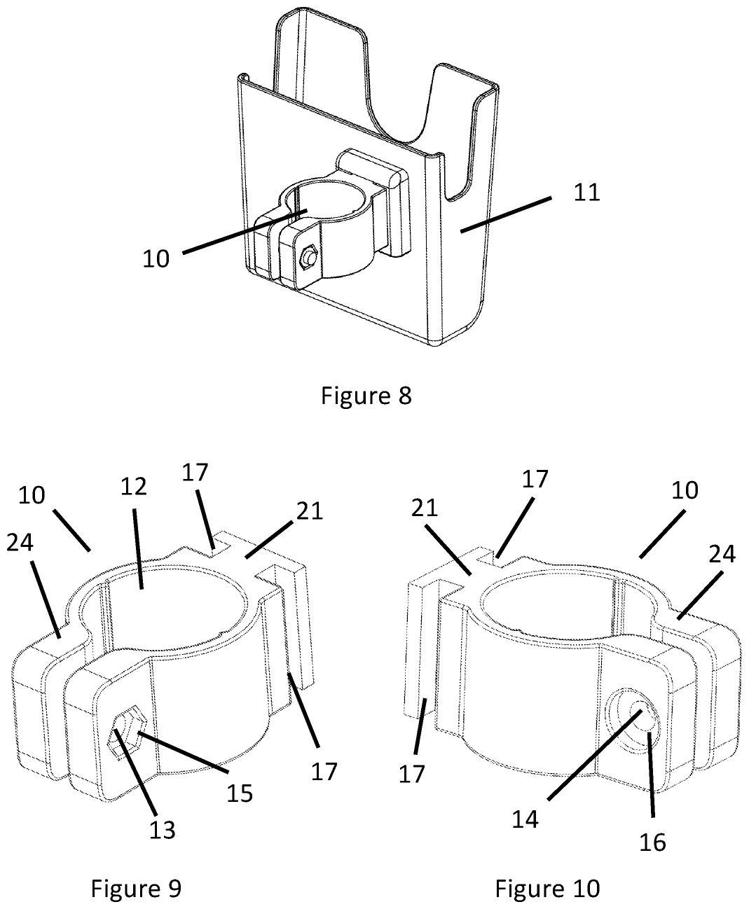

FIG. 8 shows a further embodiment of a device holder for an inversion table. This embodiment has a clamp (10) and a body (11). The clamp (10) may be rigidly attached to the inversion table, and the body (11) may be rigidly attached to the clamp (10). The clamp may be installed at any section of the inversion table that will accommodate the clamp (10). One example is shown in FIG. 17, where the device holder is installed on the left handle of the inversion table. The clamp (10) may be installed on a non-rotating portion of inversion table, such as the frame 1A, so that a device placed in the device holder does not fall out as a user inverts on the rotatable backrest 1B. The device holder may be installed on the rotatable portion of the inversion table but preferably the holder would have a mechanism at the top to retain the device and prevent the device from falling out of the device holder.

FIG. 9 illustrates the clamp (10) from the right-hand side. The clamp (10) includes an opening (12) to fit around a portion of the inversion table. While many shapes and sizes may be selected, the example shown is a round opening shaped to fit a handle on the inversion table. The clamp (10) also includes an installation opening (13) in tabs (24) that may be opened to fit the clamp (10) around the desired installation section of the inversion table. While the clamp (10) is made of a rigid material, such as plastic, it still may have sufficient flexibility to open large enough to fit around the desired installation section of the inversion table, such as a handle.

The clamp tabs (24) around the installation opening (13) may have tightening holes (14) through which a tightening mechanism, such as a nut and bolt, may be used. Optionally, the clamp (10) may have a hex cavity (15) and a tightening cavity (16) (see FIG. 10) adjacent the tightening holes (14). The hex cavity (15) may hold the head of a bolt and a nut may be installed onto the bolt into the tightening cavity (16). Alternatively, the hex cavity (15) may hold a nut and a bolt or screw may be installed onto the nut into the tightening cavity (16). By tightening the installation opening (13) (narrowing the opening), the inside area of the clamp (10) is reduced and thereby tightening the clamp around the desired section of the inversion table.

The clamp (10) includes installation grooves (17) that will accept tongues (19) on the device holder body (11). The size and shape of the grooves (17) correspond to the size and shape of the device holder tongues (19) to securely hold the device holder body (11) onto the clamp (10).

As shown in FIG. 10, the tightening hole (14) is located adjacent one of the tightening holes (14).

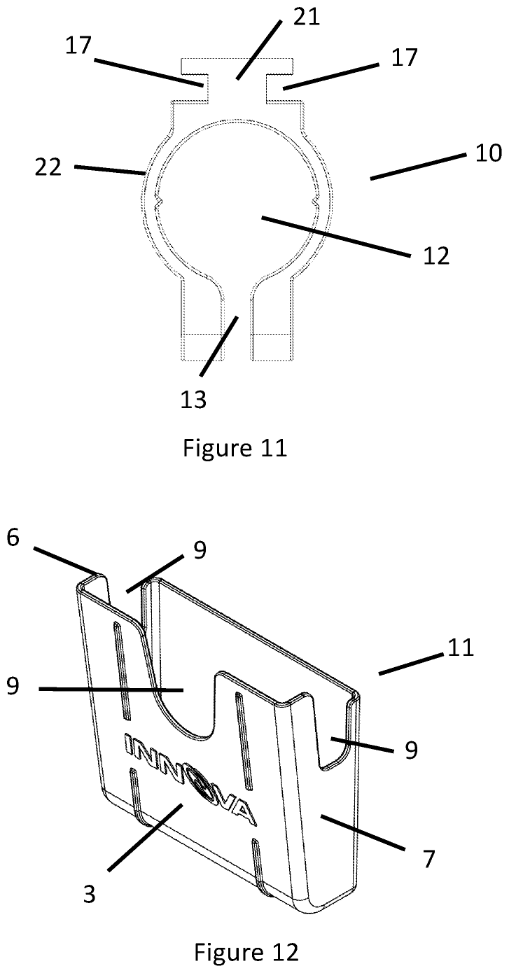

FIG. 11 shows a top view of the installation grooves (17), clamp opening (12), and installation opening (13). As the installation opening (13) is widened, clamp body (22) flexes, thus allowing the installation opening (13) to widen. In one embodiment, the installation opening (13) and clamp body (22) are flexible enough to allow the opening (13) to pass around the desired installation area of the inversion table, such as a handle. Alternatively, the clamp (10) may be slid into an end piece section of the inversion table and then tightened onto the inversion table.

As can be appreciated from the description, the clamp (10) and described tightening design allows the clamp to be removed or adjusted to different positions on the inversion table. For example, the clamp may be installed on either handle (23) of the inversion table frame 1A. The clamp may be further adjusted by installing the clamp on a specific location along a handle (23). This provides a user with choice and flexibility on the desired location of the device holder. For example, the location may be selected based on whether the user is right-handed or left-handed or based on the reach of a user's arms.

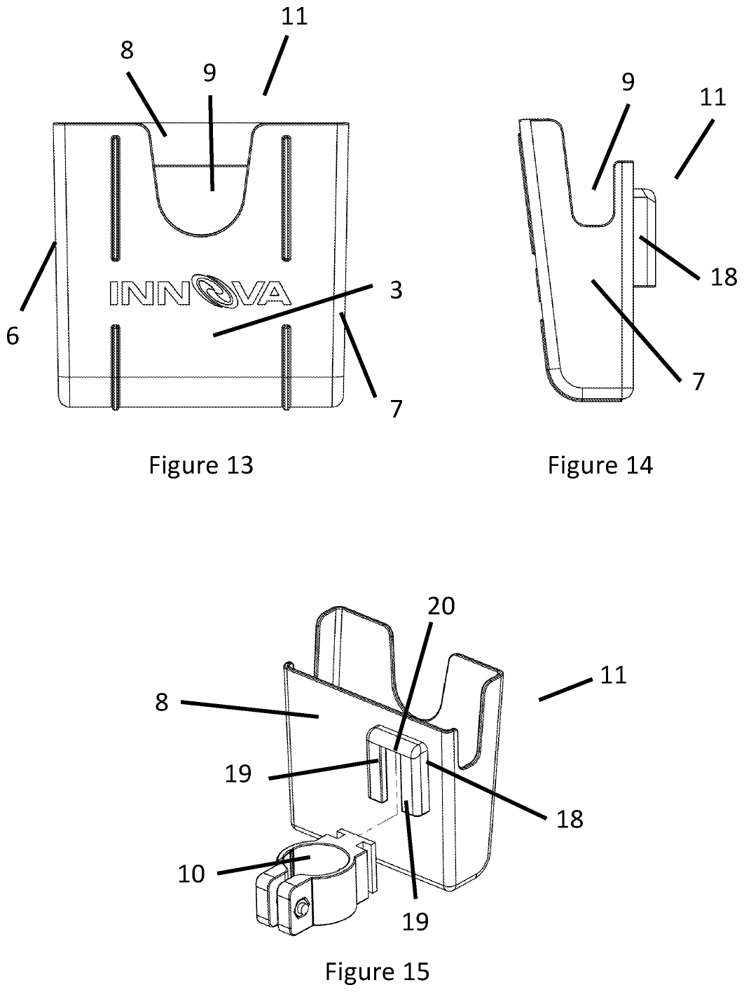

FIGS. 12, 13, and 14 show various views of the device holder body (11). FIG. 12 shows the device holder front portion (3), lateral portions (6) (7), and back portion (9). The device holder body (11) may also include slots (9). Slots (9) may be useful to assist a user with grabbing a device out of the device holder. FIG. 13 shows the lateral portions (6) (7), front portion (3), back portion (8), and slot (9).

FIG. 14 shows a side view of the device holder body (11), including an installation mount (18). As shown in FIG. 15, the installation mount (18) is located on the back portion (8) of the body (11). The mount (18) includes two tongues (19) that are shaped to correspond to the grooves (17) in the clamp 10. The length of the tongues (19) may correspond to the length of the clamp grooves (17). The installation mount (18) may include a stop (20) at the top region above the tongues (19).

As the tongues (19) of the device holder body (11) are placed into the clamp grooves (17), the stop (20) will eventually make contact with a top surface (21) of the clamp, thereby stopping additional downward movement of the device holder body (11). A potential intended path of installation of the device holder body (11) onto the clamp is shown in FIG. 15. The device holder body (11) may be removed from the clamp (10) by moving the stop (20) away from the clamp (10). This allows the device holder body (11) to be removably installed or attached onto the clamp (10). The clamp (10) as described also is removably installed or attachable to the inversion table.

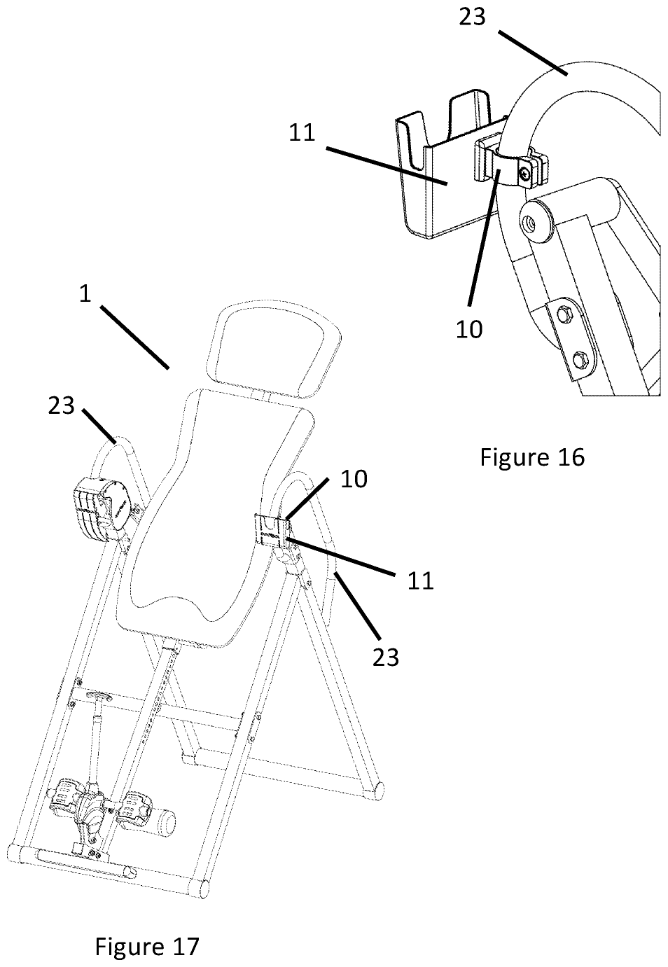

The installation of the device holder body (11) onto the clamp (10) is shown in FIG. 8. Installation of the entire device holder (10) (11) onto a handle (23) of the inversion table is shown in FIG. 16. A view of the entire inversion table with the device holder installed is shown in FIG. 17. The holder may be installed on either handle (23) or at different positions along a handle (23).

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

What is claimed is:

1. An inversion table comprising:
a frame having a handle,
a backrest rotatably connected to the frame,
a clamp removably attached to the handle,
a device holder body removably attached to the clamp, the holder body comprising
a front portion having a bottom end, a first side end, and a second side end,
a bottom portion connected to the bottom end of the front portion,
a back portion connected to the bottom portion,
a first lateral portion connected to at least one of the first side end of the front portion, the bottom portion, or the back portion,
a second lateral portion connected to at least one of the second side end of the front portion, the bottom portion, or the back portion.

2. The inversion table of claim 1, wherein
the handle has a cross sectional shape,
the clamp further comprises
a body having an opening with a shape corresponding to the cross-sectional shape of the handle,
a groove in the body having a continuous shape along the longitudinal axis of the clamp, and
a stop surface on the body located proximate an end of the groove.

3. The inversion table of claim 2, wherein
the device holder body further comprises a tongue having a continuous shape along the longitudinal axis of the body, wherein the shape corresponds to the shape of the groove.

4. The inversion table of claim 2, wherein
the clamp body further comprises a tightening mechanism.

5. The inversion table of claim 4, wherein
the tightening mechanism comprises a first tab and a second tab each having an opening.

6. The inversion table of claim 5, wherein
the first tab opening further comprises a hexagonal opening.

7. The inversion table of claim 6, wherein
the second tab opening further comprises a cylindrical opening having a diameter larger than the tab opening.

8. The inversion table of claim 7, wherein
the groove in the clamp body is located at an end of the clamp body opposite of the first tab and second tab.

9. The inversion table of claim 2, wherein
the device holder body further comprises a stop located proximate one end of the tongue.

10. The inversion table of claim 2, wherein
the device holder body has a top end with a slot in the top end and a retention device located proximate the top end.
